(19) United States
(12) Patent Application Publication
(10) Pub. No.: US 2014/0129499 A1
(43) Pub. Date: May 8, 2014

(54) VALUE ORIENTED ACTION RECOMMENDATION USING SPATIAL AND TEMPORAL MEMORY SYSTEM

(71) Applicant: NUMENTA, INC., Redwood City, CA (US)

(72) Inventor: Jeffrey C. Hawkins, Atherton, CA (US)

(73) Assignee: NUMENTA, INC., Redwood City, CA (US)

(21) Appl. No.: 13/669,156

(22) Filed: Nov. 5, 2012

(51) Int. Cl. G06N 5/02

(52) U.S. Cl. 706/46

(57) ABSTRACT

Embodiments relate to recommending actions based on costs or benefits associated with predictions generated by a spatial and temporal memory system. The spatial and temporal memory system may generate a prediction indicating that more than one value or state may take place in the future where each value or state is associated with different costs and benefits. A configuration assistant facilitates a user to define costs and benefits associated with the more than one value or state. The spatial and temporal memory system uses the likelihood distribution in prediction, and its associated costs and benefits to recommend an action.

### CROSS-REFERENCE TO RELATED APPLICATIONS

This application is related to U.S. patent application Ser. No. 13/658,200, filed on Oct. 23, 2012 and entitled “Performing Multistep Prediction Using Spatial and Temporal Memory.” (Attorney Docket No. 25172-21080).

### BACKGROUND

1. Field of the Disclosure

Embodiments relate to recommending actions based on predictions using a predictive model, and more specifically to using costs or benefits associated with actions to recommend actions.

2. Description of the Related Arts

Predictive analytics refers to a variety of techniques for modeling and data mining current and past data sets to make predictions. Predictive analytics allows for the generation of predictive models by identifying patterns in the data sets. Generally, the predictive models establish relationships or correlations between various data fields in the data sets. Using the predictive models, a user can predict the outcome or characteristics of a transaction or event based on available data. For example, predictive models for credit scoring in financial services factor in a customer's credit history and data to predict the likeliness that the customer will default on a loan.

Commercially available products for predictive analytics include products from IBM SSPS, KXEN, FICO, TIBCO, Portrait, Angoss, and Predixion Software, just to name a few. These software products use one or more statistical techniques such as regression models, discrete choice models, time series models and other machine learning techniques to generate useful predictive models. These software products generate different predictive models having different accuracies and characteristics depending on, among others, the amount of training data and available resources.

Assuming that a perfect predictive model can be generated, all future patterns and sequences should be predicted based on the current state or value and actions can be taken based on the predicted state or value without other considerations. However, in reality, most predictive models generate inaccurate predictions due to various reasons such as imperfections in the modeling or the lack of sufficient training data. Hence, the prediction made using a predictive model will often deviate from the actual value or state being predicted.

### SUMMARY

Embodiments are related to taking an action based on costs associated with relying on values or states predicted to occur at a future time. A likelihood distribution of a plurality of values or states that may occur at the future time is generated using a predictive model and input data received at an earlier time. The likelihood distribution represents likelihood that each of the values or states occurs at the future time. For each of the predicted values or states, a cost associated with taking an action in anticipation of the predicted values or states is determined. An action to be taken is selected by comparing the costs associated with actions corresponding to the plurality of values or states.

In one embodiment, the selected action has a lowest associated cost among the actions.

In one embodiment, user input associated with defining the costs in anticipation of each of the plurality of values or states is received.

In one embodiment, the predictive model is implemented by a spatial and temporal memory system that learns temporal transitions in spatial patterns derived from the input data.

In one embodiment, the second time is a plurality of time steps after the first time.

In one embodiment, user input for configuring operational parameters of the predictive model is received.

In one embodiment, display information for sequentially displaying user interface screens is generated. Each user interface screen is associated with receiving of user input for setting different operational parameters.

In one embodiment, the likelihood distribution is generated by performing spatial pooling to identify spatial patterns in the input data, and performing temporal processing to identify the plurality of values or states based on stored association between transitions of the spatial patterns.

### BRIEF DESCRIPTION OF THE DRAWINGS

The teachings of the embodiments of the present invention can be readily understood by considering the following detailed description in conjunction with the accompanying drawings.

FIG. 1 is a diagram illustrating a value matrix according to one embodiment.

FIG. 2A is a conceptual diagram of a single processing node in a non-hierarchical system, according to one embodiment.

FIG. 2B is a conceptual diagram illustrating a hierarchical spatial and temporal memory system including three layers of processing nodes, according to one embodiment.

FIG. 2C is a conceptual diagram illustrating a hierarchical spatial and temporal memory system with multiple processing nodes at lower levels, according to one embodiment.

FIG. 3 is a block diagram illustrating a spatial and temporal memory system according to one embodiment.

FIG. 4 is a block diagram illustrating a processing node in the spatial and temporal memory system of FIG. 3, according to one embodiment.

FIG. 5A is a block diagram illustrating a sequence processor in the processing node of FIG. 4, according to one embodiment.

FIG. 5B is a conceptual diagram illustrating a structure of a cell, according to one embodiment.

FIG. 6 is a block diagram illustrating a configuration assistant according to one embodiment.

FIG. 7A is a flowchart illustrating the process of configuring the spatial and temporal memory system, according to one embodiment.

FIG. 7B is a flowchart illustrating the process of recommending an action based on a value matrix, according to one embodiment.

FIGS. 8A through 8F are diagrams illustrating graphical user interface screens for configuring the spatial and temporal memory system, according to one embodiment.

### DETAILED DESCRIPTION OF EMBODIMENTS

In the following description of embodiments, numerous specific details are set forth in order to provide more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left most digits of each reference number corresponds to the figure in which the reference number is first used.

Embodiments relate to recommending actions based on costs or benefits associated with predictions generated by a spatial and temporal memory system. The spatial and temporal memory system may generate a prediction indicating that more than one value or state may take place in the future where each value or state is associated with different costs or benefits. A configuration assistant facilitates a user to define costs or benefits associated with the more than one predicted value or state. The spatial and temporal memory system generates the likelihood distribution for the one or more predicted value or state and their associated costs or benefits to recommend an action. One of many advantages of taking costs or benefits associated with predictions into account is that the recommended actions are more likely to be in line with values and objectives that are relevant to the user.

### VALUE DEFINITION OF PREDICTED VALUES OR STATES

Although it is advantageous to generate a more accurate predictive model, the predictive model may make inaccurate predictions due to various reasons such as imperfections in the predictive model, limited training data, and unexpected changes in the behavior of the system being predicted. Such inaccuracies in the prediction may be reduced through improved model and more training. However, inaccuracies in the prediction may not be removed completely. Inaccurate predictions often entail certain costs (or benefits) to a user. Hence, it is practical to assume that there will be some degree of inaccuracies in the predictions, and focus rather on recommending actions that are likely to increase the benefit and decrease the cost to the user despite the presence of such inaccuracies in the predictions.

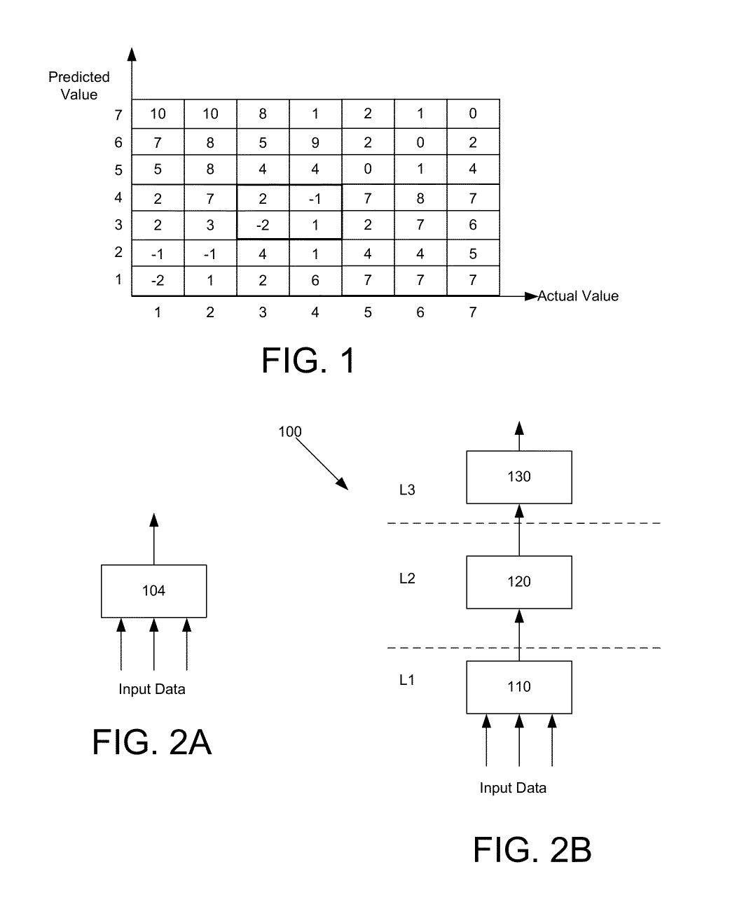

The costs and benefits to the inaccuracies (or accuracies) of the predictions can be defined in various ways. One way of defining the costs of benefits of predictions is through the use of a value matrix. A simplified example of the value matrix is illustrated in FIG. 1 where the actual future value may take a value from 1 through 7 (as show in columns of FIG. 1). The spatial and temporal memory system can generate distribution of likelihood that the future predicted values will be 1 through 7 (as shown in rows of FIG. 1). For each combination of a predicted value shown in a row and an actual future value shown in a column), a cost value is assigned to a box where the row and the column intersect to indicate the cost or benefit to the user when each combination occurs. For example, when the predicted value is 7, and the user takes an action based on that prediction, but the actual value is 1, the cost to the user is 10 in FIG. 1. The higher cost value indicates that the cost to the user is higher. The negative cost value indicates that the combination inures to the benefit to the user. Usually the lowest cost occurs when the action taken by the user is based on a prediction that matches the actual value.

If it is necessary to avoid a certain combination of predicted value and actual future value, the cost assigned to the cost value assigned to the combination may be set to a very high value. Similarly, if a certain combination of predicted value and actual future value is very beneficial and preferred, the cost value can set to a significantly negative value.

In the example of FIG. 1, the cost of an action tends to decrease as the discrepancy between the predicted value and the actual future value decreases. However, the cost associated with the prediction tends to be higher when discrepancy is due to lower actual input data and a higher predicted value. Such tendency indicates a scenario where the cost penalty is more severe for over-estimation of the future value. An example of such scenario would involve preparation of perishable goods that become unmarketable unless sold at the exact future time. If the user prepared excessive goods for sale which did not materialize, the cost associated with unmarketable goods would be severe whereas the lost profit associated with preparing a fewer number of goods would be minor.

An example of computing the recommended action using the value matrix of FIG. 1 is described herein. Assume that the prediction made by the spatial and temporal memory system indicates that the probability of the future value corresponding to 3 is 0.4 and the probability of the future value corresponding to 4 is 0.6 and the probability of the future value taking a value other than 3 or 4 is zero. That is, the likelihood distribution is vector (0, 0, 0.4, 0.6, 0, 0, 0) where each element indicates the probability that a value of 1, 2, 3, 4, 5, 6 or 7 occur in the future. Under such assumptions, the calculation of cost or benefit can be made respect to only the actual input data value and predicted value pairs of (3, 3), (3, 4), (4, 3) and (4, 4) (shown by thicker lines in FIG. 1) since the likelihood that an actual value of 1, 2, 5, 6 of 7 occurring in the future is zero.

In one embodiment, the cost associated with an action for each predicted value can be calculated by adding up the cost when the prediction is correct multiplied by the probability that the prediction is correct and each cost associated with an action associated with inaccurate prediction multiplied by the probability that such inaccurate prediction occurs in the future. In the above example, the cost associated with predicting the value of 3 is −0.2, which is obtained by −2 (a cost value when the predicted value of 3 matches the actual future value of 3) multiplied by 0.4 (probability that the prediction of 3 is correct) plus 1 (a cost value when the prediction was 3 but the actual value is 4) multiplied by 0.6 (probability that the prediction of 4 is correct). Similarly, the cost associated with predicting the value of 4 is 0.2, which is obtained by −1 (a cost value when the predicted value of 4 matches the actual future value of 4) times 0.6 (probability that the prediction of 4 is correct) plus 2 (a cost value when the predicted value is 4 but the actual future value is 3) times 0.4 (probability that the prediction of 3 is correct). Since the cost of acting on the value of 3 (which is −0.2) is lower than the cost of acting on the value of 4 (which is 0.2), it is advantageous to take an action based on the assumption that the future value will be 3 despite the fact that the distribution vector indicates that the future value is more likely to be 4 than 3.

The use of a value matrix and the method of computing costs are merely illustrative. The costs or benefits associated with predictions may be defined in other forms such as equations, a multiple choice issue or a natural language statement (e.g., keep errors below 1600). In one embodiment, templates of predefined value matrixes are assigned to certain multiple choice elections or natural language statement. The templates may be updated and finalized according to input provided by the user. Further, a value matrix may be configured to define different types of costs or benefits, which may be considered to decide a prediction value or state upon which to base actions.

The process of defining the value matrix or the cost function itself is advantageous to the user in that the user is forced to contemplate on the costs or benefits associated with different actions in light of different actual outcomes. Further, the value matrix or other definition of costs or benefits to user may provide user with a mechanism to clearly define otherwise abstract concept of costs or benefits to user, and also enables recommendation of actions that increases benefits and reduces costs to the user by numerical computation.

### Architecture of Spatial and Temporal Memory System

In one or more embodiments, a spatial and temporal memory system is used for embodying the predictive model to recommend actions based on costs or benefits associated with predicted values or states. In other embodiments, predictive models other than the spatial and temporal memory system is used to make predictions and recommend actions based on costs or benefits associated with predicted values or states.

A spatial and temporal memory system stores temporal relationships in sequences of spatial patterns and generates useful information based on the stored relationships. The useful information may include, for example, prediction of spatial patterns to be received, identification of temporal sequences of spatial patterns or a higher level cause associated with the sequences of spatial patterns in input data. The spatial and temporal memory system may be of a non-hierarchical structure or be of a hierarchical structure.

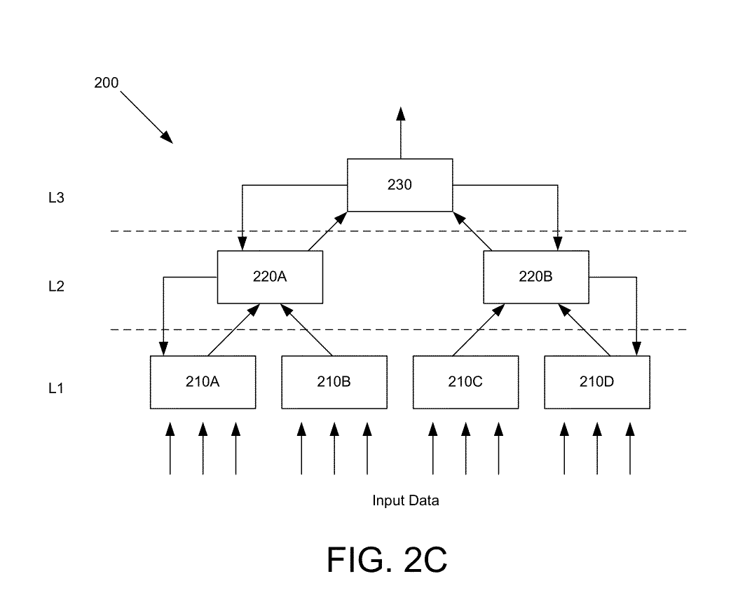

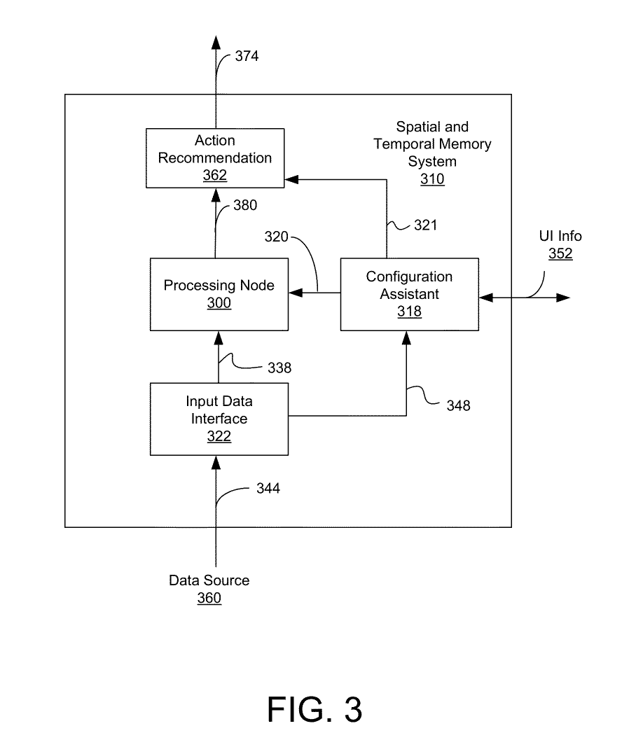

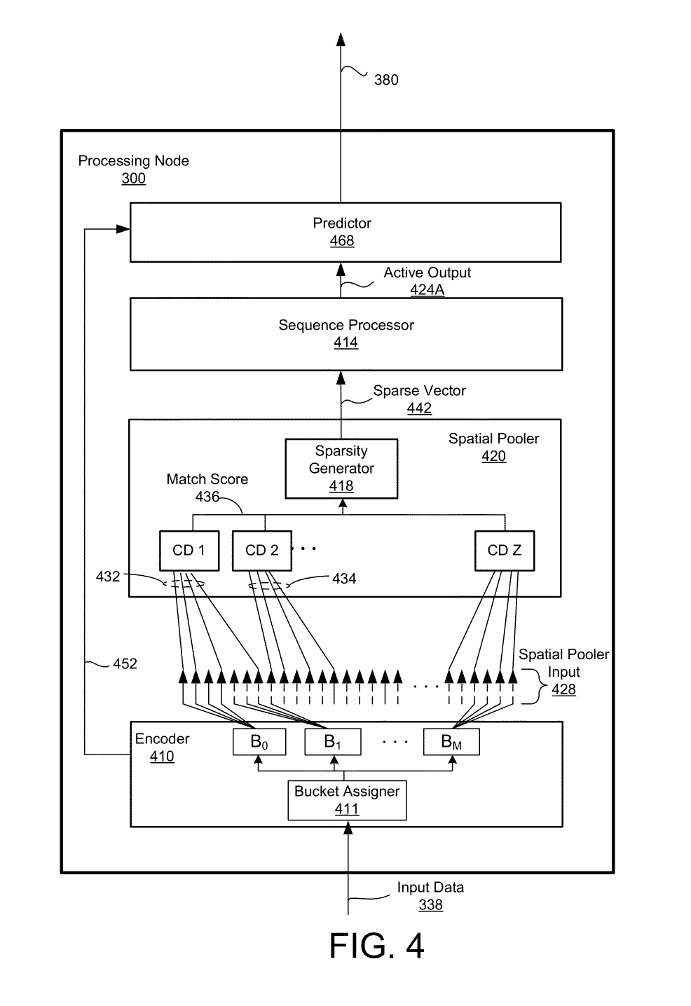

FIG. 2A is a conceptual diagram of a single processing node 104 in a non-hierarchical system, according to one embodiment. The processing node 104 receives input data, processes temporal sequences in the input data and generates an output. The output of the processing node 104 is based on the temporal relationships between spatial patterns. For example, the output may indicate prediction on what spatial patterns are to follow or indicate how well the prediction matched a subsequent spatial pattern in the input data.

FIG. 2B is a conceptual diagram of processing nodes organized in a hierarchical manner. Such hierarchically structured spatial and temporal memory system is referred to as a Hierarchical Temporal Memory (HTM) system. In an HTM system, multiple processing nodes learn, predict and infer input at different levels of abstraction. An example HTM system 100 of FIG. 2B comprises three levels where each level L1, L2 and L3 includes one processing node 110, 120 and 130, respectively. HTM system 100 has three levels L1, L2, L3, with level L1 being the lowest level, level L3 being the highest level, and level L2 being an intermediate level between levels L1 and L3. Processing node 110 at the lowest level L1 receives a sensed input that changes over time. Processing node 110 processes the sensed input and outputs a signal that is fed to its parent node 120 at level L2. Processing node 120 at level L2 in turn processes the signal from processing node 120 and outputs a signal to processing node 130 at the highest level L3. Processing node 120 outputs a signal that represents likely causes or events associated with the input data.

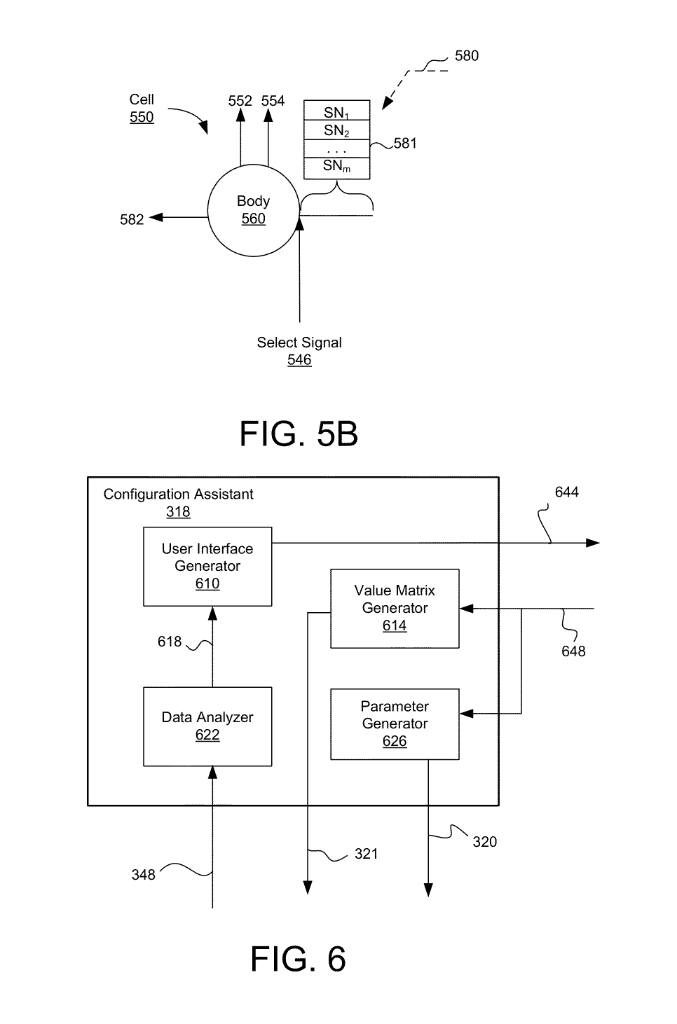

Each processing node 110, 120, 130 may perform spatial pooling and/or temporal processing, as described below in detail with reference to FIG. 4. As a result, the output signals from each processing node 110, 120, 130 are more abstract or invariant over time compared to their input signals. In one embodiment, the top node 130 generates a final output of HTM system 100 that is of the highest abstraction (e.g., likely causes or events) among the outputs generated in HTM system 100. The final output may include distributions indicating likelihood that certain causes or events are associated with the sensed input.

Some of many functions performed by a processing node include, for example, spatial pooling and temporal processing. The spatial pooling herein refers to the process of mapping a set of distinct but similar spatial patterns into a spatial co-occurrence. The temporal processing may include, but is not limited to, learning temporal sequences, performing inference, recognizing temporal sequences, predicting next elements in temporal sequences, labeling temporal sequences and temporal pooling. The learning of temporal sequences herein refers to one or more of initializing, expanding, contracting, merging and splitting temporal sequences. The prediction herein refers to assessing likelihood that certain spatial patterns will appear subsequently in the input data. The temporal pooling herein refers to processing input data to provide an output that is more stable and invariable over time compared to spatial patterns in the input data. Hardware, software, firmware or a combination thereof for performing the spatial pooling is hereinafter referred to as a spatial pooler. Hardware, software, firmware or a combination thereof for performing the temporal processing is hereinafter referred to as a sequence processor. The sequence processor may perform one or more of learning temporal sequences, performing inference, recognizing temporal sequences, predicting temporal sequences, labeling temporal sequences and temporal pooling.

In one embodiment, a processing node includes only a sequence processor or the spatial pooler. For example, nodes at the first level of the HTM system may consist of processing nodes having only spatial poolers, and the nodes at the second level of the HTM system may consist of processing nodes having only sequence processors. Processing nodes performing other functions (e.g., filtering) may also be placed within the HTM system. Alternatively, a processing node may include two or more levels of interconnected sequence processors or spatial poolers.

The processing nodes of the HTM system may be arranged so that the number of processing nodes decreases as level increases. FIG. 2C is a diagram illustrating HTM system 200 having three levels L1, L2, L3, with level L1 being the lowest level, level L3 being the highest level, and level L2 being an intermediate level between levels L1 and L3. HTM system 200 is hierarchically structured so that the processing nodes cover a larger input space as the level ascends. Level L1 has nodes 210A, 210B, 210C and 210D; level L2 has nodes 220A and 220B; and level L3 has node 230. Nodes 210A, 210B, 210C, 210D, 220A, 220B, and 230 are hierarchically connected in a tree-like structure such that each processing node has several children nodes (that is, nodes connected at a lower level) and one parent node (that is, node connected at a higher level).

Further, HTM system 200 propagates bottom-up signals up the hierarchy as well as propagates top-down signals down the hierarchy. That is, each processing node 210A, 210B, 210C, 210D, 220A, 220B, and 230 may be arranged to (i) propagate information up the HTM hierarchy to a connected parent node, and (ii) propagate information down the HTM hierarchy to any connected children nodes.

The number of levels or arrangement of processing modes in FIGS. 2B and 2C are merely illustrative. Many variants of HTM system may be developed and deployed depending on the specific application. For example, the number of levels may be increased to provide different levels of abstraction/invariance or to accommodate different types of sensed inputs (e.g., visual data and audio data). Further, a parent node may also receive partially overlapping bottom-up signals from multiple children nodes. An external supervision signal may also be fed to each of the processing nodes to enhance spatial and/or temporal processing performance.

In one embodiment, one or more nodes of the spatial and temporal memory system receives input data representing images, videos, audio signals, sensor signals, data related to network traffic, financial transaction data, communication signals (e.g., emails, text messages and instant messages), documents, insurance records, biometric information, parameters for manufacturing process (e.g., semiconductor fabrication parameters), inventory patterns, energy or power usage patterns, data representing genes, results of scientific experiments or parameters associated with operation of a machine (e.g., vehicle operation) and medical treatment data. The spatial and temporal memory system may process such inputs and produce an output representing, among others, identification of objects shown in an image, identification of recognized gestures, classification of digital images as pornographic or non-pornographic, identification of email messages as unsolicited bulk email (‘spam’) or legitimate email (‘non-spam’), prediction of a trend in financial market, prediction of failures in a large-scale power system, identification of a speaker in an audio recording, classification of loan applicants as good or bad credit risks, identification of network traffic as malicious or benign, identity of a person appearing in the image, processed natural language processing, weather forecast results, patterns of a person's behavior, control signals for machines (e.g., automatic vehicle navigation), gene expression and protein interactions, analytic information on access to resources on a network, parameters for optimizing a manufacturing process, predicted inventory, predicted energy usage in a building or facility, web analytics (e.g., predicting which link or advertisement that users are likely to click), identification of anomalous patterns in insurance records, prediction on results of experiments, indication of illness that a person is likely to experience, selection of contents that may be of interest to a user, indication on prediction of a person's behavior (e.g., ticket purchase, no-show behavior), prediction on election, prediction/detection of adverse events, a string of texts in the image, indication representing topic in text, and a summary of text or prediction on reaction to medical treatments. The underlying representation (e.g., photo, audio and etc.) can be stored in a non-transitory storage medium.

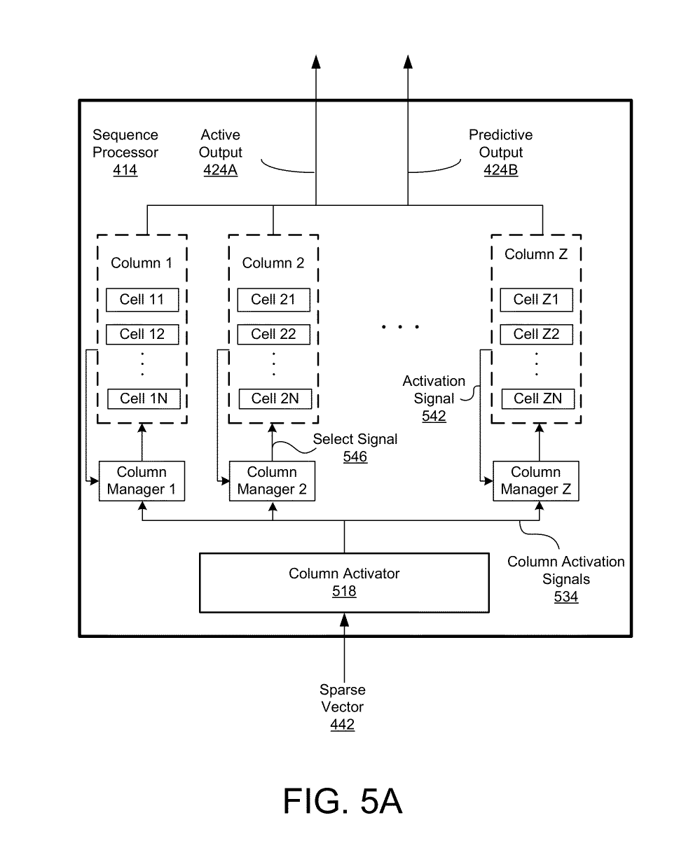

FIG. 3 is a block diagram illustrating spatial and temporal memory system 310 according to one embodiment. Spatial and temporal memory system 310 may include, among other components, processing node 300, input data interface 322, action recommendation module 362 and configuration assistant 318. Input data interface 322 is hardware, software, firmware or a combination thereof for interfacing with data source 360 to retrieve raw data 344. Data source 360 may be any device capable of providing data that is indexed with time. Data source 360 may include, for example, a database and a sensor. Input data interface 322 retrieves raw data 344 and converts it into input data 338 for further processing at processing node 300. Input data interface 322 may also receive and send sample data 348 to configuration assistant 318.

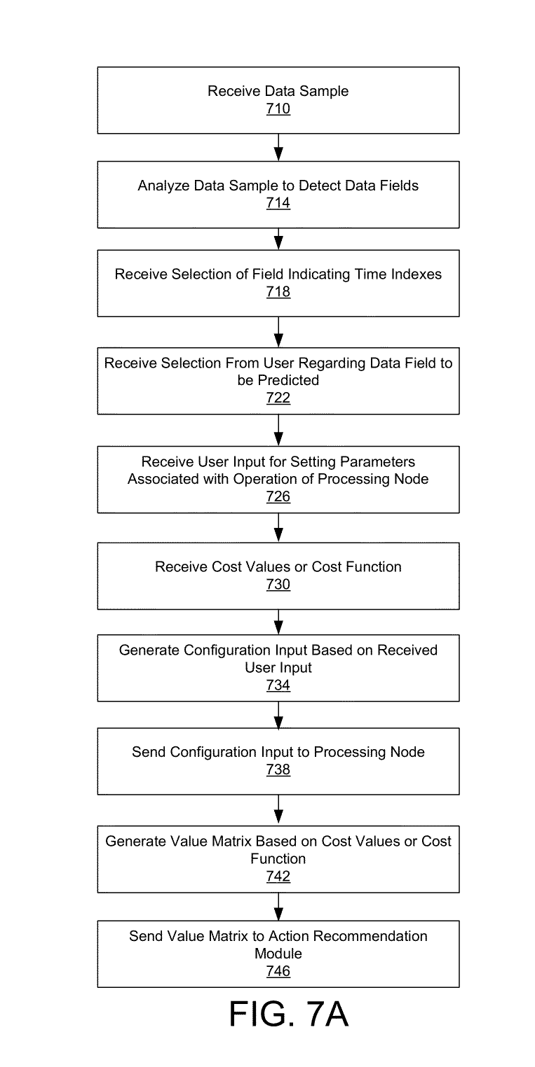

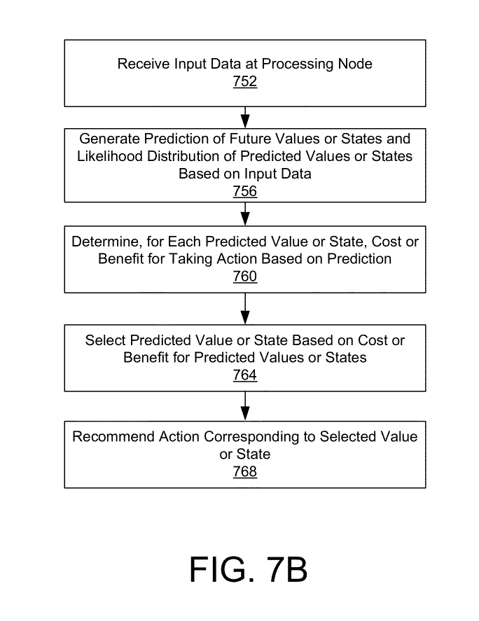

Processing node 300 is hardware, software, firmware or a combination thereof for performing spatial and/or temporal processing. Processing node 300 generates predictions 380 based on received input data 338. Although only a single processing node 300 is illustrated in FIG. 3, a plurality of processing nodes 300 may be arranged in a hierarchical manner as illustrated in FIGS. 2B and 2C. Example structures of processing node 300 are described below in detail with reference to FIGS. 4 through 5B.

In one embodiment, prediction 380 indicates values or states that can occur in the future and distribution indicative of likelihood that such values or states will occur in the future. For example, prediction 380 may be a vector in the form of (p₁, p₂, . . . , pₘ) where each element p₁ through pₘ in the vector indicates the likelihood or probability that a corresponding future value or state will occur in the future.

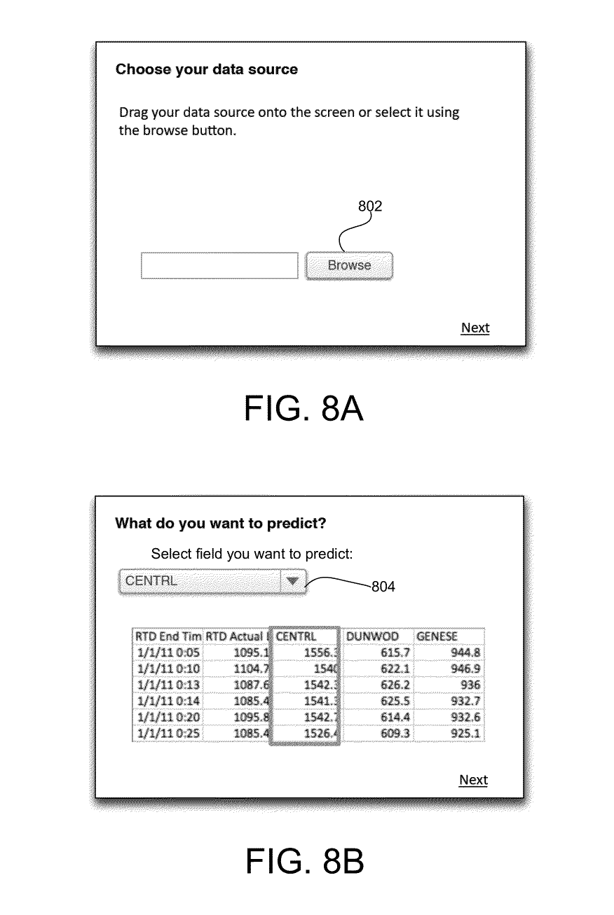

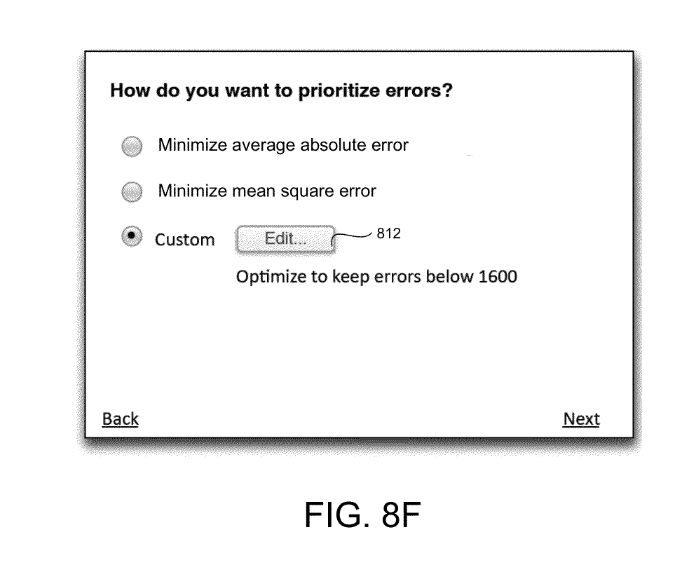

Configuration assistant 318 is hardware, software, firmware or a combination thereof for configuring spatial and temporal memory system 310 based on user input. Configuration assistant 318 may communicate user interface (UI) information 352 with the user. UI information 352 may include, for example, information to display graphical user interface as illustrated in FIGS. 8A through 8F. Based on the user input, configuration assistant 318 generates value matrix 321 and sends the matrix to action recommendation module 362. In lieu of value matrix 321, a cost function indicating a cost value as a function of the predicted value or state and the actual value or state may be sent from configuration assistant 318 to action recommendation module 362. Configuration assistant 318 also generates configuration input 320 for setting various operating parameters in processing node 300. An example structure of configuration assistant 318 is described below in detail with reference to FIG. 6.

Parameters as defined by configuration input 320 may include, but are not limited to the following: (i) identification of encoding schemes to be used for encoding input data, (ii) the number of cells and columns in sequence processor of processing node 300 (as described below in detail with reference to FIG. 5A), (iii) the number of co-occurrence (CD) detectors in spatial pooler 420 of processing node 300 (as described below in detail with reference to FIG. 4), (iv) if multistep predictions are made, the number of time steps associated with the predictions, and (v) whether online learning (i.e., simultaneous learning and prediction) is to be enabled. A time step herein refers to a unit of time during which a temporal sequence in input data of the spatial and temporal system is deemed to persist without any change. A multistep prediction herein refers to making predictions of values or state to appear multiple time steps after a current time.

Action recommendation module 362 is hardware, software, firmware or a combination thereof for generating recommended actions 374 based on predictions 380. In action recommendation module 362, each predicted value or state or ranges or value or state are mapped to certain actions. Action recommendation module 362 receives predictions 380 from processing node 300, and computes the costs or benefits associated with each recommended action based on value matrix 321. Based on the computed costs or benefits, the action recommendation module 362 chooses an action mapped to the predicted value or cost that yields decreased cost or increased benefit.

The actions to be recommended may include, but are not limited to, controlling various operational parameters of a machine, purchasing or selling financial instruments, assigning the number or amount of resources to be reserved for the future time, planning manufacturing or production of goods, assigning employees to different tasks, accepting or declining transactional offers, and changing the cost structure of services or goods.

FIG. 4 is a block diagram illustrating processing node 300 in a spatial and temporal memory system, according to one embodiment. The processing node 300 may be a stand-alone node for operating without other processing nodes. Alternatively, the processing node 300 may be part of a hierarchy of processing nodes, for example, as described above in detail with reference to FIGS. 2B and 2C.

Processing node 300 may include, among other components multiple time steps (MS) predictor 468, sequence processor 414, spatial pooler 420 and encoder 410. In one embodiment, processing node 300 is a combination of hardware and software. Processing node 300 may include a processor for executing instructions and software modules for storing instructions for one or more functions of components as illustrated in FIG. 4.

Encoder 410 receives input data 338 and encodes the input data 338 into spatial pooler input 428. Spatial pooler input 428 is one type of spatial pattern derived from the input data 338 and is in a distributed representation form suitable for further processing at processing node 300 using various types of encoding schemes, as described, for example in U.S. patent application Ser. No. 13/218,170, entitled “Encoding of Data for Processing in a Spatial and Temporal Memory System,” filed on Aug. 25, 2011, which is incorporated by reference herein in its entirety. Specifically, encoder 410 may receive data of various types (e.g., enumerated types, scalar data and a hybrid thereof) and convert these data into spatial pooler input 428 in a distributed representation. In case the input data 338 includes multiple data fields, encoder 410 may apply a different coding scheme for each data field and concatenate the converted data into a single spatial pooler input 428.

In one embodiment, encoder 410 includes bucket assigner 411 that receives input data 338 and activates one or more buckets B₀ through B_{M}. Each of the buckets B₀ through B_{M} may be associated with a plurality of elements in spatial pooler input 428. When a bucket turns active, elements of the spatial pooler input 428 associated with the bucket also turns active. In the example of FIG. 4, bucket B₀ is active (indicated by solid arrows) whereas bucket B₁ and B_{M} are inactive (indicated by dashed arrows). Encoder 410 also sends active bucket information 452 indicating which buckets are active to predictor 468. For example, active bucket information of (1, 0, 0, 0, 0) indicates that the first bucket is active whereas the other four buckets are inactive. Bucket information 452 is another type of spatial pattern derived from the input data 338.

If the processing node 300 forms a non-hierarchical system or is a lowest node of a hierarchical system, the input data 338 may be sensed input. If the processing node 300 is a node at an intermediate level or a top level of a hierarchical system, the input data 338 may be an output from a child node or children nodes.

Spatial pooler 420 performs spatial pooling by producing sparse vector 442 in sparse distributed representation. In a sparse distributed representation, a number of elements in the sparse vector 442 are inactive (e.g., assigned a value of zero) while the remaining elements are active (e.g., assigned a value of one). Referring to FIG. 4, spatial pooler 420 includes, among other components, a sparsity generator 418 and a plurality of co-occurrence detectors (CDs) 1 through Z. CDs detect co-occurrences in spatial pooler input 428, and generate match scores 436. Match scores 436 indicate the degree of match between a spatial pattern of the spatial pooler input 428 and a co-occurrence pattern associated with each CD. In one embodiment, a higher match score indicates more overlap between spatial pooler input 428 and the associated co-occurrence pattern of each CD. The match scores 336 are provided to sparsity generator 418. In response, sparsity generator 418 generates sparse vector 4342 in sparse distributed representation.

In one embodiment, each CD is mapped to a subset of elements in the spatial pooler input 428 within a predefined input range. As illustrated in FIG. 4 by lines extending from CD 1 to a subset of arrows of spatial pooler input 428, CD 1 is mapped to receive a subset 432 of elements of the spatial pooler input 428. Similarly, CD 2 is mapped to receive a subset 434 of elements of the spatial pooler input 428.

Sparsity generator 418 collects the match scores 436 from the CDs, selects a number of CDs satisfying conditions based on their match scores and match scores of nearby CDs to generate sparse vector 442. In one embodiment, when a CD becomes dominant (i.e., the CD has a high match score), the CD inhibits selection of other CDs within a predetermined range (hereinafter referred to as “an inhibition range”). The inhibition range may extend only to CDs immediately adjacent to the dominant CD or may extend to CDs that are separated from the dominant CD by a predetermined distance. Alternatively, sparsity generator 418 may select a subset of CDs with highest match scores among all CDs in the processing node.

Sequence processor 414 performs temporal processing based on sparse vector 442, and generates active output 424A and predictive output 424B. Active output 424A and predictive output 424B collectively represent activation state of columns, cells and/or temporal memory segments of the cells in the sequence processor 414, as described below in detail with FIG. 5A.

Predictor 468 generates prediction 380 indicating distribution of likelihood of states or values predicted to take place one time step or multiple time steps in the future based on active output 424A and/or other information. Active output 424A indicates the current activation state of the sequence processor 414. In one embodiment predictor 468 stores the relationships between the active outputs 424A and future active bucket information 452, and uses the stored relationships to generate and output prediction 380. Prediction 380 indicates a value or a state predicted to take place multiple time steps in the future. Alternatively or additionally, prediction 380 may include predictive output 424B indicating a predicted value or state in a time step immediately after the current time step.

FIG. 5A is a block diagram illustrating sequence processor 414, according to one embodiment. Sequence processor 414 learns and stores transitions between spatial patterns represented as sparse vector 442 over time by establishing connections between cells and, for each cell, storing activation states of other connected cells that precede its activation. Based on the learned transitions, sequence processor 414 recognizes and predicts the same or similar transitions in the input signal by monitoring the activation states of its cells.

Sequence processor 414 may include, among other components, columns of cells (in dashed boxes), column managers and column activator 518. Column activator 518 receives sparse vector 442 from spatial pooler 420. In response, column activator 518 generates column activation signals 534 indicating which columns are to be activated based on sparse vector 442. The column activator 518 receives sparse vector 442 and determines which elements of sparse vector 442 are active. Then, column activator 518 sends column activation signals 534 to corresponding columns to activate cells in these columns. Each column is connected to an associated column manager. The column manager receives the column activation signal 534, determines activation states of cells in the column (based on activation signal 542), and sends select signal 546 to activate one or more cells in the column under certain circumstances.

In one embodiment, sequence processor 414 may learn, store and detect temporal sequences while performing inference, prediction or other temporal processing (also referred to as “online learning” herein). The online learning collapses a learning (or training) phase and a temporal processing (e.g., predicting) phase into a single phase.

Example embodiments of processing node 300 described above with reference to FIGS. 4 and 5A are merely illustrative. Other types of processing nodes using a different algorithm or operating principle to process spatial patterns and temporal sequences may be adopted. For example, a processing node may implement an algorithm described, for example, in U.S. Pat. No. 8,037,010, entitled “Spatio-Temporal Learning Algorithms in Hierarchical Temporal Networks,” issued on Oct. 11, 2011, which is incorporated by reference herein in its entirety.

The spatial and temporal memory system 310 or its components may be embodied by instructions executable by a processor and stored on a non-transitory computer readable storage medium.

### Example Structure of Cells

One or more cells are included in each column. The cells may be activated by select signals 446 at the current time step (hereinafter referred to as “non-predictive” activation) or by receiving sequence inputs from other connected cells (hereinafter referred to as “predictive” activation). The sequence inputs represent the activation states of cells in columns other than the column in which a particular cell belongs, and can be used to activate the particular cell based on the activation of cells in the other columns. The cells individually, or collectively as a column, send active output 424A and prediction output 424B to predictor 468.

FIG. 5B is a conceptual diagram illustrating signals associated with a cell 550, according to one embodiment. Cell 550 receives sequence inputs 580 and select signal 546. Sequence inputs 580 are collective sequence outputs sent out by other cells having connections with cell 550. Cell 550 establishes connections with the other cells during learning to monitor the activation states of the other cells. Cell 550 also receives select signal 546 which becomes active when: (i) the column including cell 550 is activated by column activation signal 534, and (ii) cell 550 is selected to learn activation states of other cells. After activation, cell 550 also sends a sequence output 582 to other cells. The sequence output 582 in conjunction with the sequence output from other cells form sequence inputs for other cells.

Cell 550 generates non-predictive cell output 552 and predictive cell output 554. Non-predictive cell output 552 is generated when the cell 550 is activated in response to select signal 546 (which is in turn generated in response to column activation signals 534). Non-predictive cell output 552 in conjunction with non-predictive cell outputs from other cells form active output 502 representing non-predictive activation of cells at a current time step. Predictive cell output 554 is generated when the cell 550 is activated in response to sequence inputs 580. Predictive cell output 554 in conjunction with predictive cell outputs from other cells form prediction output 504 representing predictive activation of cells based on the sequence inputs.

Cell 550 includes a table 581 storing sets of activation states upon activation of cell 550. Each of the entries SN₁ through SNₘ correspond to a set of activation state of cells connected to cell 550 when cell 550 was activated. When the sequence inputs 580 indicate activation states of other cells that match totally or partially with one set of activation states as stored in an entry of table 581, cell 550 body 560 outputs predictive cell output 554.

In one embodiment, entries in table 581 store identifications of a subset of cells active when cell 550 was first activated. For example, the subset may consist of ten cells that are a subset of 100 cells that were active when cell 550 was activated. The cells for storing information about the vector may be selected randomly or based on certain criteria.

As multiple vectors are detected, a list of vectors may be generated for the selected cell. After learning, the cell is activated when sequence input includes a vector completely matches to one of the list of vectors that the cell is storing or the number/percentage of elements matching the list of vectors exceed a threshold.

### Example Structure of Configuration Assistant

FIG. 6 is a block diagram illustrating configuration assistant 318 according to one embodiment. Based on user input 648, configuration assistant 318 generates value matrix 321 and configuration input 320. Configuration assistant module 318 may include, among other components, user interface generator 610, data analyzer 622, value matrix generator 614, and parameter generator 626.

Data analyzer 622 receives sample data 348 from input data interface 322 and determines one or more fields in raw data 344 that are likely represent time indexes, as described below in detail with reference to FIG. 8C. Sample data 348 is a subset of raw data 344 used for determining or surmising types of information in each field of raw data 344. Data analyzer 622 may also analyze other fields of raw data 344 to determine if these fields are likely to represent certain types of data. As a result of analysis, data analyzer 622 generates and sends data field information 618 to user interface generator 610. Data field information 618 represents information about data fields in raw data 344.

User interface generator 610 generates various display information 644 for presentation to the user. Display information 644 may include, among other information, information for displaying graphical user interface screens on a computing device. User interface generator 610 sequentially generates a series of graphical user interface screens, and in response, enables configuration assistant 318 to receive user input 648 from the user in an organized and sequential manner. At least one graphical user interface screens present the result of analyzing sample data 348 by data analyzer 622.

Value matrix generator 614 generates value matrix 321 based on received user input 648. User interface generator 610 may generate a graphical user interface screen, as described below in detail with reference to FIG. 8F. The user may provide cost values for combinations of the predicted value and the actual input value in the form of a value matrix or a function that enables the cost values for various combinations of predicted value and actual input value to be calculated. Value matrix generator 614 sends value matrix 321 to action recommendation module 362. Alternatively, value matrix generator 614 may send the function or equation that enables calculation of cost values to action recommendation module 362.

Parameter generator 626 generates configuration input 320 based on user input 648 received from the user. Configuration input 320 defines one or more parameters associated with the operation of processing node 300, as described above in detail with reference to FIG. 3. In one embodiment, parameter generator 626 may store default sets of parameters that can be chosen based on, for example, data field information 618. Such default sets of parameters may enable convenient configuration of processing node 300 using a reduced number of user feedback.

The structure of configuration assistant 318 of FIG. 6 is merely illustrative. Configuration assistant 318 may include other components to provide additional functionality to spatial and temporal memory system 310.

### Example Process of Configuring Spatial and Temporal Memory System

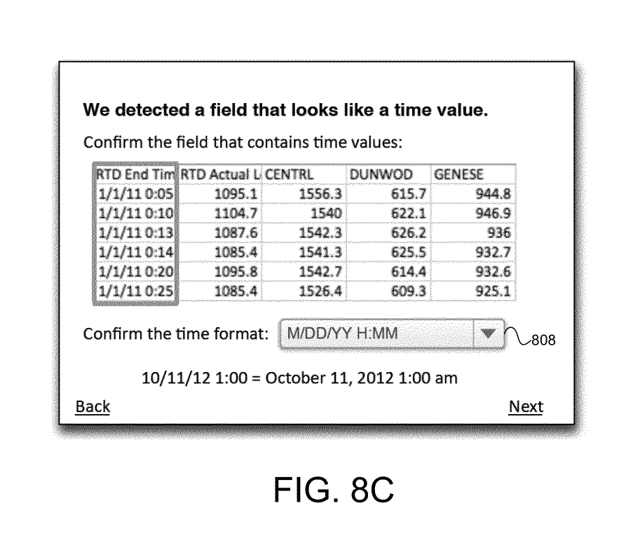

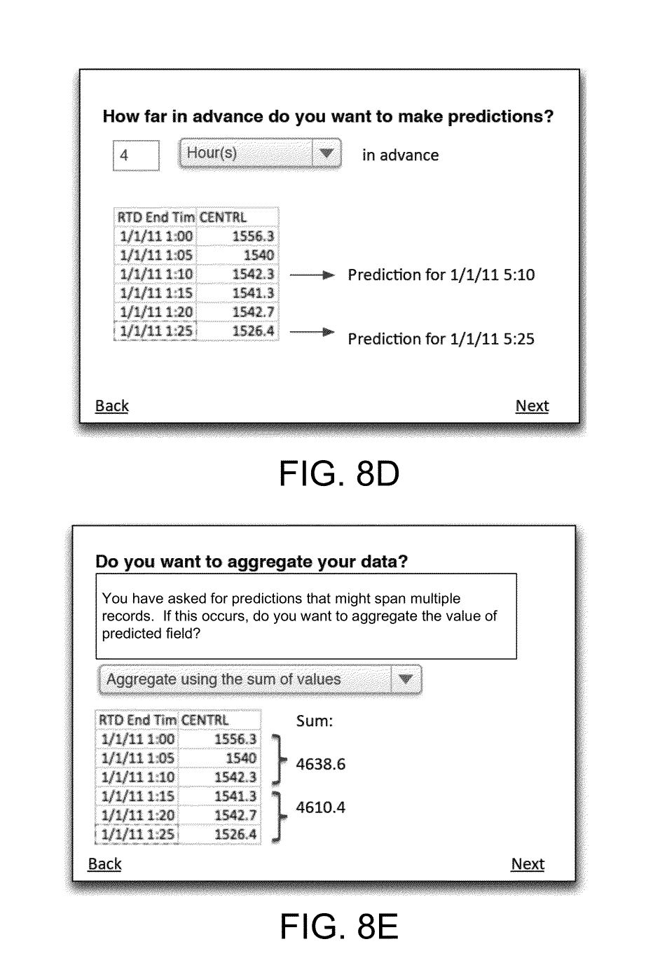

FIG. 7A is a flowchart illustrating the process of configuring the spatial and temporal memory system 310, according to one embodiment. Configuration assistant 318 receives 710 sample data 348 from data source 360 via input data interface 322. Configuration assistant 318 analyzes 714 sample data to detect various types of data fields (e.g., a data field including time indexes).

The result of the analysis may be presented to the user, for example, as described below in detail with reference to FIG. 8C. In response, configuration assistant 318 receives 718 selection of a field indicating time indexes.

Configuration assistant 318 also receives 722 selection from user regarding a data field to be predicted, for example, as described below in detail with reference to FIG. 8B. Configuration assistant 318 also receives 726 user input for setting parameters associated with the operation of processing node 300. Graphical user interface screens for setting such parameters are described, for example, below in detail with reference to FIGS. 8D and 8E.

Configuration assistant 318 also receives 730 cost values for combinations of predicted value and actual future value or a cost function that enable calculation of such cost values.

Based on the received user input, configuration input 320 is generated 734. Configuration input 320 is then sent to 738 to processing node 300 to configure the operational parameters of processing node 300.

A value matrix is also generated 742 based on received cost values or the cost function. The generated value matrix is then sent 746 to action recommendation module 362.

The process and the order of steps described above with reference to FIG. 7A are merely illustrative. Some of the steps as illustrated in FIG. 7A may be reversed in order or performed in parallel. For example, the steps of generating 734 and sending 738 configuration inputs may be performed after the steps of generating 742 and sending 746 the value matrix. Alternatively, the steps of generating 734 and sending 738 configuration inputs may be performed in parallel with the steps of generating 742 and sending 746 the value matrix. Further, the steps of receiving 710 and/or analyzing 714 sample data may be omitted.

### Example Process of Recommending Action Using Value Matrix

FIG. 7B is a flowchart illustrating the process of recommending an action based on a value matrix, according to one embodiment. Input data 338 is received 752 at processing node 300. In response, processing node 300 generates 756 prediction of future values or states and likelihood distribution of these predicted values or states based on input data 338.

For each predicted value or state, a cost or benefit for taking an action in anticipation of the predicted value or state is determined 760. An example of determining the cost or benefit is described above in detail with reference to FIG. 1.

Among the predicted values or states, a value or state is selected 764 based on the cost or benefit for taking action based on the predicted values or states. In one embodiment, a value or state that results in the lowest cost (or the highest benefit) is selected.

After selecting the value or state, an action corresponding to the selected value or state is recommended 768 to the user. Alternatively, a recommended action may be taken automatically without user intervention.

### Example Graphical User Interface Screens for Configuring Spatial and Temporal Memory System

FIG. 8A is a graphical user interface screen displayed to identify data source 360, according to one embodiment. The user may press button 802 and provide an address or pointer to data source 360 to receive raw data 344 from data source 360.

FIG. 8B is a graphical user interface screen displaying sample data 348, according to one embodiment. In this example, sample data has five different data fields, each indicated by a different column. The interface includes a drop-down menu 804 that allows the user to identify the data field to be predicted.

FIG. 8C is a graphical user interface screen for indicating a data field likely to include time indexes. Since the spatial and temporal memory system learns and performs predictions based on sequences of spatial patterns, if there is a data field it needs to be identified. In this example, configuration assistant 318 determines that the likely data field including time indexes is the first data field. The user can confirm which data field includes time indexes, and specify the format of the data field using a pull-down menu 808.

FIG. 8D is a graphical user interface screen for setting how far in the future the predictions should represent. The user can specify a number and units as shown in FIG. 8D.

FIG. 8E is a graphical user interface screen for setting how aggregated data should be treated if aggregation occurs. The setting associated with the aggregation of data is used for configuring the encoding scheme used in encoder 410.

FIG. 8F is a graphical user interface for providing cost values or cost function, according to one embodiment. In this example screen, at least three options of setting cost values or the cost function are provided: (i) minimize average absolute error, (ii) minimize the square of errors and (iii) setting of custom cost values or a cost function. When customizing cost values or functions, the user can provide the cost values, the cost functions or statements pertaining to these by pressing edit button 812.

The graphical user interface screens of FIGS. 8A through 8F are merely illustrative. Interface screens of various configurations (e.g., text based user interface) may be used instead of the graphical user interface illustrated in FIG. 8A through 8F. Further, the graphical user interface screens may or may not be in the order of FIG. 8A through 8F.

Although above examples and embodiments were described primarily with respect to predictions where future values or states are predicted based on a sequence of inputs over time, the same principle may be applied when predictions are based solely on one input at the current time. In such embodiment, a module for performing inference would replace predictor 468, and the costs or benefits would be associated with making correct or incorrect inference based on the current input data.

Upon reading this disclosure, those of skill in the art will appreciate still additional alternative designs for processing nodes. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A computer-implemented method comprising:
receiving input data at a first time;
generating likelihood distribution of a plurality of values or states likely to occur at a second time subsequent to the first time by processing the input data using a predictive model, the likelihood distribution representing likelihood of each of the plurality of values or states occurring at the second time;
determining, for each of the plurality of predicted values or states, a cost associated with taking an action in anticipation of each of the plurality of values or states occurring at the second time;
comparing costs for actions associated with the plurality of values or states; and
selecting an action based on the compared costs.

2. The method of claim 1, wherein the selected action has a lowest associated cost among the actions.

3. The method of claim 1, further comprising receiving user input associated with defining the costs in anticipation of each of the plurality of values or states.

4. The method of claim 3, wherein the user input comprises a matrix defining a plurality of cost values as a function of the plurality of predicted values or states and actual values or states at the second time.

5. The method of claim 3, wherein the user input comprises a function defining cost values as a function of the plurality of predicted values or states and actual values or states at the second time.

6. The method of claim 1, wherein the predictive model is implemented by a spatial and temporal memory system learning temporal transitions in spatial patterns derived from the input data.

7. The method of claim 6, wherein the second time is further in future compared to a time at which a next input data is received.

8. The method of claim 1, further comprising receiving user input for setting at least one of (i) a data field in the input data to be predicted, (ii) an interval between the first time and the second time, and (iii) the costs in anticipation of each of the plurality of values or states.

9. The method of claim 8, further comprising generating display information for sequentially displaying user interface screens, each user interface screen associated with receiving of user input for configuring different operational parameters.

10. The method of claim 1, wherein generating the likelihood distribution comprising:
performing spatial pooling to identify spatial patterns in the input data; and
performing temporal processing to identify the plurality of values or states based on stored association between transitions of the spatial patterns.

11. The method of claim 1, further comprising:
receiving a subset of the input data for analysis; and
determining a field in the subset of the input data likely to include time indexes based on the analysis, wherein the predictive model is trained by sequentially processing information of the input data based on the time indexes.

12. The method of claim 1, wherein the cost is determined, for each of the plurality of predicted values or states, based on a cost value for correctly predicting a value or a state for the second time and another cost value for incorrectly predicting the value or the state for the second time.

13. An apparatus, comprising:
a processing node configured to:
receive input data at a first time, and
generate likelihood distribution of a plurality of values or states likely to occur at a second time subsequent to the first time by processing the input data using a predictive model, the likelihood distribution representing likelihood of each of the plurality of values of values or states occurring at the second time; and
an action recommendation module configured to:
determine, for each of the plurality of predicted values or states, a cost associated with taking an action in anticipation of each of the plurality of values or states occurring at the second time,
compare costs for actions associated with the plurality of values or states, and select an action based on the compared costs.

14. The apparatus of claim 13, wherein the selected action has a lowest associated cost among the actions.

15. The apparatus of claim 13, further comprising a configuration assistant configured to:
receive first user input associated with defining the costs in anticipation of each of the plurality of values or states;
configure the action recommendation module based on the first user input;
receive second user input for setting operational parameters of the predictive model; and
configure the processing node based on the second user input.

16. The apparatus of claim 15, wherein the user input comprises a matrix with a plurality of cost values as a function of the plurality of predicted values or states and actual values or states at the second time.

17. The apparatus of claim 15, wherein the user input comprises a function defining cost values as a function of the plurality of predicted values or states and actual values or states at the second time.

18. The apparatus of claim 13, wherein the processing node is configured to form relationships between temporal transitions in spatial patterns derived from the input data.

19. The apparatus of claim 14, wherein the configuration assistant is further configured to generate display information for sequentially displaying user interface screens, each user interface screen associated with receiving of user input for configuring different operational parameters.

20. A non-transitory computer readable storage medium configured to store instructions, when executed by a processor cause the processor to:
receive input data at a first time;
generate likelihood distribution of a plurality of values or states likely to occur at a second time subsequent to the first time by processing the input data using a predictive model, the likelihood distribution representing likelihood of each of the plurality of values or states occurring at the second time;
determine, for each of the plurality of predicted values or states, a cost associated with taking an action in anticipation of each of the plurality of values or states occurring at the second time;
compare costs for actions associated with the plurality of values or states; and
select an action based on the compared costs.
